(19) United States
(12) Patent Application Publication
(10) Pub. No.: US 2017/0273278 A1
(43) Pub. Date: Sep. 28, 2017

(54) Pet Washing Device

(71) Applicants: Saeid Tavafi, Rancho Cucamonga, CA (US); Saman Jannati, Rancho Cucamonga, CA (US)

(72) Inventors: Saeid Tavafi, Rancho Cucamonga, CA (US); Saman Jannati, Rancho Cucamonga, CA (US)

(21) Appl. No.: 15/481,195

(22) Filed: Apr. 6, 2017

(51) Int. Cl. A01K 13/00

(52) U.S. Cl. CPC A01K 13/001

(57) ABSTRACT

The Pet Washing Device includes a transparent enclosure with a removable lid having a plurality of inwardly facing water jets secured subjacent the lid on one (1) widthwise face. The manifold extends outside the enclosure and has a fitting at a distal end which is capable of being threading secured to a water source. This device utilizes a pump to recycle water and conserve water consumption. In addition, it is equipped with a blower to enable a faster drying cycle for pets.

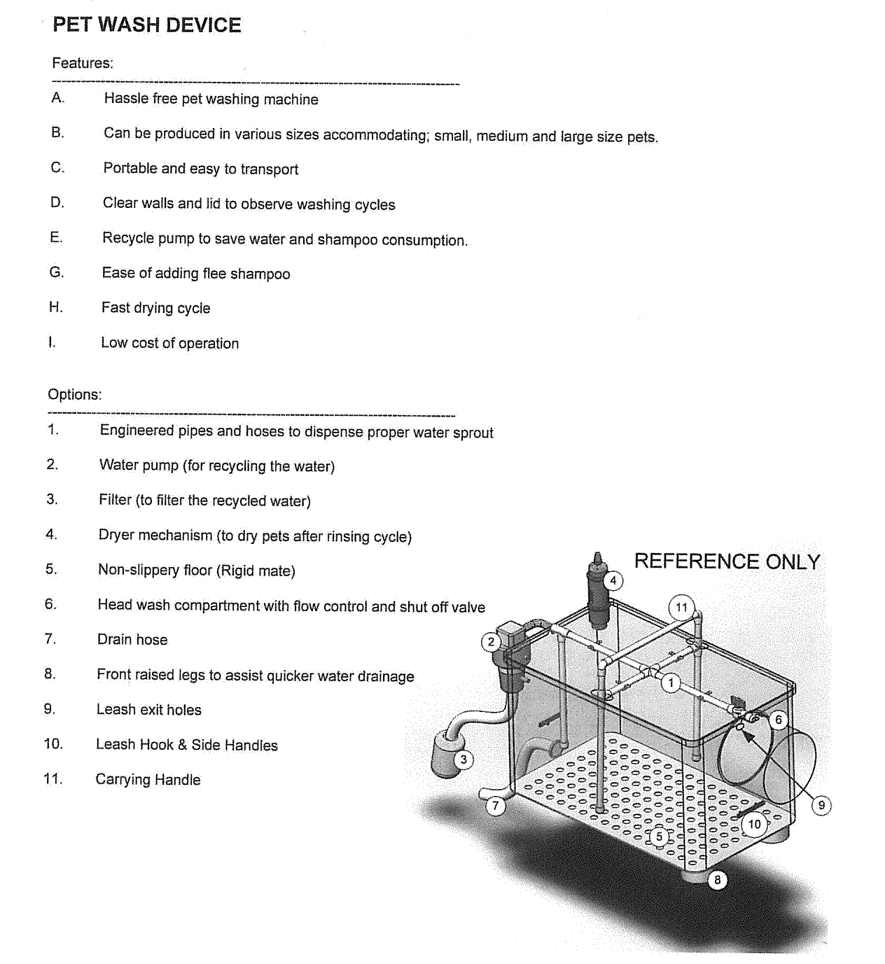

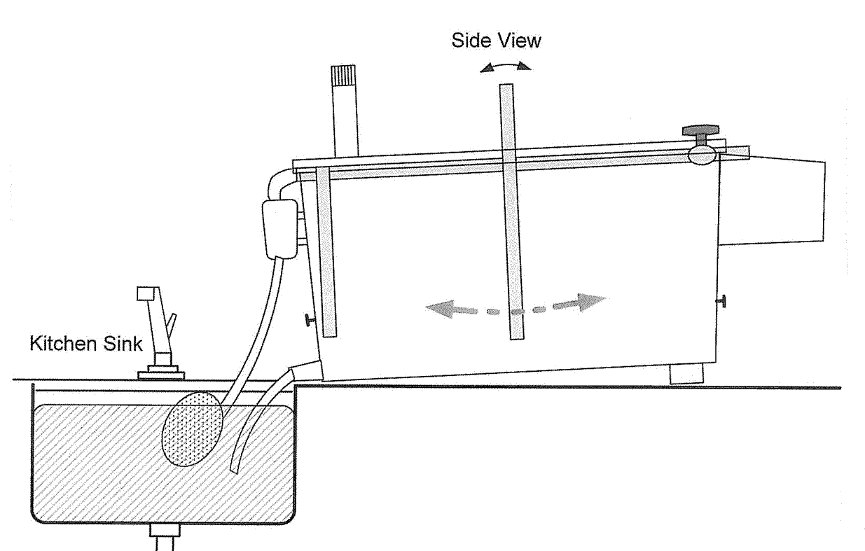

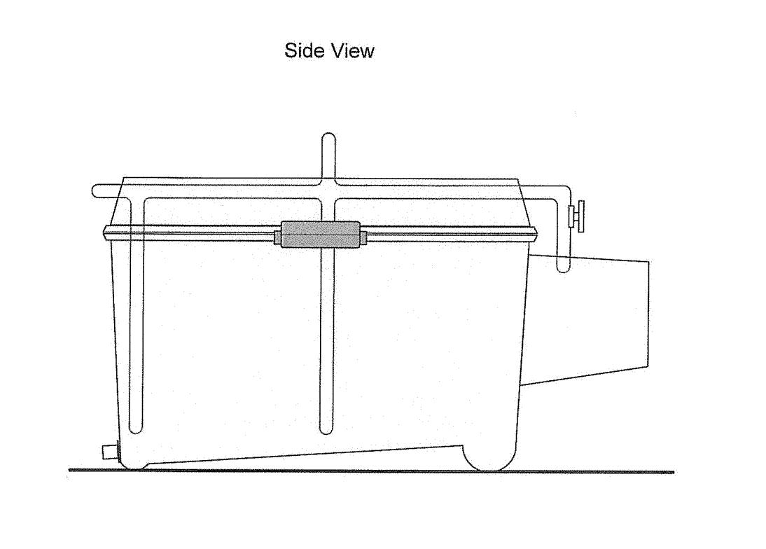

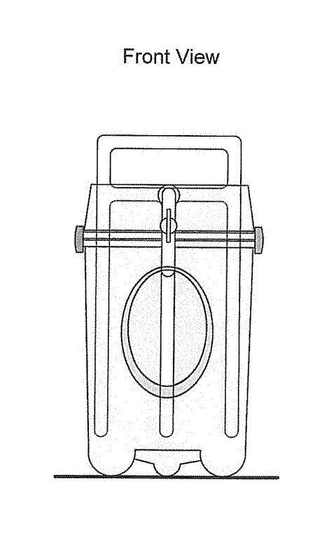

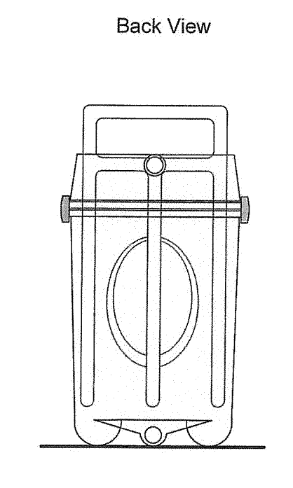

### CROSS-REFERENCE TO RELATED APPLACTIONS

“Not Applicable”

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM

“Not Applicable”

### STATEMENT REGARDING PRIOR DISCLOSURES BY THE INVENTOR OR A JOINT INVENTOR

“Not Applicable”

### BACKGROUND OF THE INVENTION

### Technical

The material required to produce the Pet Washing Device are all readily available and well known to manufacturer of goods of this type. The box, lid and many of the components of the invention would be made of plastic in an injection molding process. Such a process would require the design and use of custom molds. The remaining opponents of the invention, such as the hose, spray nozzles, drain opening, and the like, would best obtained in bulk from manufacturers or wholesalers who deal in goods of that nature. The relatively simple deign of the invention and the material of construction make the Pet Washing Device a cost-effective design due to the relatively low material and labor costs involved. Final production of the Pet Washing Device will be performed by manufacturing workers of average skill.

### Description of Related Art: Features and Benefits

1. Pet Grooming Appliance: Holds Cat or Dog During Bathing and Grooming Process Helps Prevent Owner From Becoming Scratched, Attacked, Wet or Dirty. Provides Complete Washing And Drying Care In One Device. Makes It Easy To Bathe/Groom Pet At Home.
2. Enclosure: Takes The Form Of A Box. Typical Sized Box For A Medium Sized Dog Would Be 18 Inches Tall, 24 Inches Long, And 14 Inches Deep. Designed Such That The Cat Or Dog Can Be Placed Within The Enclosure And Completely Sealed Inside With A Locking Lid. Pet's head And Neck Can Stick Out An Opening At One End If Desired.
3. Hose: Hooked Up To Water Source Such As Sink Faucet. Used With Liquid Shampoo Application System To Wash The Animal And Without Shampoo To Rinse. Uses Water Jet System For Hands Free Operation.
4. Drain Opening: Drains Waste Water From Invention After Use. Waste Water Is Carried Away to Conventional Floor Drain As Found In Shower Or Garage Floor. Drain Can Also Be Closed To Recirculate The Water For Water Conservation.
5. Blower/Heater System: Air Is Blown Through Same Hose/Nozzle System. Provided To Dry The Pet While Still Inside The Invention. Provides Complete Coverage. Ideal For Cold Weather Climates.
6. Material Construction: Readily Available Material. Easy to Manufacture. Strong and Durable. Lightweight. Easy To Clean and Maintain. Known Technology. Cost-Effective Design.

### BRIEF SUMMARY OF THE INVENTION

The Pet Washing Device, as its name implies, is an Apparatus to aid in the bathing of pets such as cats or dogs. The invention takes the form of a box that is placed over a floor drain as found in a shower or garage or even on a kitchen counter.

### BRIEF DESCRIPTION OF THE SEVERAL VIEWS OF THE DRAWING(S)

1. PWD-001 Page 1 of 5: Full View Reference Only

2. PWD-001 Page 2 of 5: Side View Interaction With Kitchen Sink

3. PWD-001 Page 3 of 5: Side View of Invention

4. PWD-001 Page 4 of 5: Front View of Invention

5. PWD-001 Page 5 of 5: Back View of Invention

### DETAILED DESCRIPTION OF THE INVENTION

While the size of the box can vary per the size of the pet being bathed, a typical sized box for a medium sized dog would be 18 inches tall, 24 inches long, and 14 inches deep. It is designed such that the cat or do can be placed within the enclosure and completely sealed inside with a lock lid. The pet' head and neck can stick out an opening at one end if desired. A hose, hooked up to a common water tap, along with a built in liquid shampoo application system is used to was the animal through a series of pressurized jets. The bottom drain can be closed to recirculate the water if desired to aid in water conservation. When completed, the animal is automatically rinsed with clean water using the same jet system. The enclosure also contains rinse water as it is shaken off of the pet. Finally, drying air can also be blown through the jets as well to aid in drying while the pet is still inside the invention. When finished, the pet is removed, the invention is allowed to dry, and then stored away until next use. The use of the Pet Washing Device allows for the washing and grooming of cats and dogs in home environment which is quick, easy and effective.

1. Keeping pets is a never-ending task, requiring one to constantly feed, groom, and clean up after their animal friends. Those that keep animals such as dogs and cats Know the importance of a frequent bathing to keep their pet's coat healthy, clean, and fresh smelling. For this bathing process, many take their pet to pet grooming salons which can quickly become expensive. Others may wash their pets in the bathtub which is tough on the back. Still others may wash their pet in a bathroom or kitchen sink if they are small enough, but run the risk of soiling all surfaces, and perhaps causing a hair-clogged drain. In all of these situations, pets such as cats who do not want to be bathed, can scratch or injure the person doing the bathing. Accordingly, there exists a need for a means by which pets such as cats and dogs can be bathed in an easy manner without the disadvantages as described above. The development of the Pet Washing Device fulfills this need.
